(19) United States
(12) Patent Application Publication
(10) Pub. No.: US 2025/0353311 A1
(43) Pub. Date: Nov. 20, 2025

(54) MANIFOLD FOR AN INKJET PRINTER

(71) Applicant: BOBST MEX SA, Mex (CH)

(72) Inventor: Walter URECH, Seengen (CH)

(73) Assignee: BOBST MEX SA, Mex (CH)

(21) Appl. No.: 18/874,172

(22) PCT Filed: Aug. 28, 2023
(86) PCT No.: PCT/EP2023/073556

§ 371 Date: Dec. 12, 2024

(30) Foreign Application Priority Data
Sep. 14, 2022 (EP) 22195673.3

(51) Int. Cl. B41J 2/20; B41J 2/175; B41J 2/18; B41J 29/377

(52) U.S. Cl. CPC B41J 2/20; B41J 2/175; B41J 2/18; B41J 29/377

(57) ABSTRACT

The invention relates to a manifold for an inkjet printer, comprising a main body (18) with an ink cavity and a temperature control fluid cavity which is in thermal contact with the ink cavity, the manifold (12) further comprising at least one ink inlet, (28) at least one ink outlet (34), at least one temperature control fluid inlet (40) and at least one temperature control fluid outlet (50), wherein the main body (18), the at least one ink inlet (28), the at least one ink outlet (34), the at least one temperature control fluid inlet (40) and the at least one temperature control fluid outlet (50) consist of the same material and form a single piece.

The invention relates to a manifold for an inkjet printer.

Inkjet printers are typically used to digitally print various products, such as labels, textiles, ceramic tiles and many more, by dispensing small ink droplets through nozzles of a printing head.

In order to achieve consistent and high-quality prints, the ink parameters, such as the ink viscosity, the ink flow rate and the ink pressure, have to be controlled precisely. If the ink viscosity is too high and/or the ink meniscus pressure too low, the ink might not be able to exit the printing head nozzles. In contrast, a too low ink viscosity or a too high meniscus pressure may result in formation of satellite droplets and overall lower print quality. Furthermore, when performing inkjet printing on porous substrates, the resulting printing dot is influenced by viscosity dependent spreading of the ink on the substrate and penetration of the ink into the substrate.

Especially in high-throughput industrial inkjet printing, the ink control is often complex and requires a sophisticated ink management system with a manifold that distributes the ink to the single print heads and controls the ink temperature such that a desired viscosity is reached.

Inkjet manifolds known from the state of the art typically comprise a plurality of many different parts, such as hoses, connectors and seals that are made from different materials and assembled together. As a result, the manifolds are prone to errors and/or disturbances, such as sealing leakage or clogging caused by formation of ink deposits, which can appear if the ink is incompatible with one of the materials the manifold consists of.

The object of the invention is to provide an inkjet manifold that is less prone to such errors and/or disturbances and thus improves the stability of the printing process.

The object of the invention is solved by a manifold for an inkjet printer, comprising a main body with an ink cavity and a temperature control fluid cavity which is in thermal contact with the ink cavity. The manifold further comprises at least one ink inlet, at least one ink outlet, at least one temperature control fluid inlet and at least one temperature control fluid outlet, wherein the main body, the at least one ink inlet, the at least one ink outlet, the at least one temperature control fluid inlet and the at least one temperature control fluid outlet consist of the same material and form a single piece.

In this context, the term “inlet” refers to openings through which a liquid can enter the manifold. The term “outlet” refers to openings through which a liquid can leave the manifold.

The proposed manifold structure with the different manifold elements forming a single piece from the same material reduces the effort for assembling the manifold. Furthermore, compared to conventional manifolds, the total number of applied individual parts and materials and thus potential points of failure is reduced.

In one embodiment, the main body, the at least one ink inlet, the at least one ink outlet, the at least one temperature control fluid inlet and the at least one temperature control fluid outlet are manufactured by rapid prototyping, in particular 3D printing, and consist of a metal.

The rapid prototyping and/or 3D printing technique enables to manufacture the main elements of the manifold in a single time and cost saving processing step, even if the manifold geometry is complex.

Preferably, the main body, the at least one ink inlet, the at least one ink outlet, the at least one temperature control fluid inlet and the at least one temperature control fluid outlet consist of titanium. This metal offers high hardness and excellent corrosion resistivity. Furthermore, titanium is antimagnetic and therefore not prone to interfere with electronic parts.

It is conceivable that the main body comprises a thermally conductive wall separating the ink cavity and the temperature control fluid cavity. In particular, the wall can be made of 3D-printed titanium. The wall prevents direct contact between the printing ink and the temperature control fluid and at the same time allows to effectively transfer heat between both liquids.

In one variant, the main body comprises a plurality of thermally conductive lamellae within the ink cavity. The lamellae may also consist of 3D printed titanium. They provide an additional contact surface between the ink and the main body through which heat can be transferred. Furthermore, the lamellae can influence the ink flow within the ink cavity such that a homogeneous velocity and/or ink pressure distribution is achieved.

In order to further improve the heat transfer between the ink and the temperature control fluid, the lamellae can be arranged such that they extend perpendicularly from the thermally conductive wall through the ink cavity. It is conceivable that the lamellae extend perpendicularly from the thermally conductive wall throughout the whole cross section of the ink cavity.

To allow ink to spread in between the lamellae and/or to flow through the whole cavity, each of the lamellae may comprise at least one opening for ink to pass through. Of course, a lamella can also comprise more than one opening. The ink openings can for example be circular and equidistantly distributed across the lamella to achieve a laminar and/or homogeneous ink flow through the ink cavity.

In one embodiment, the main body comprises a plurality of thermally conductive lamellae within the control fluid cavity. The lamella increases the contact surface between the main body and the temperature control fluid and thus the heating and/or cooling efficiency.

Preferably, the ink cavity and the control fluid cavity are both equipped with lamellae. As an example, the lamellae in the ink cavity and in the control fluid cavity can be oriented parallel or perpendicularly to each other to achieve an efficient heat transfer between the ink and the temperature control fluid across the whole cavity dimensions.

In a further embodiment, the manifold comprises at least four ink outlets, each configured to supply ink to a corresponding print head and/or ink conditioner and at least four ink inlets, each configured to return ink from the corresponding print head and/or ink conditioner such that ink can circulate between the manifold and the print heads and/or ink conditioners during a printing process. By using the manifold to supply ink to a plurality of print heads, the overall number of individual printer parts can be reduced, thus saving manufacturing costs and reducing potential causes of errors. Furthermore, the ink circulation through the manifold reduces or prevents ink deterioration, such as sedimentation and/or formation of debris inside the ink channels, thereby improving the overall stability of the printing process.

In another variant of the manifold, at least one temperature control fluid outlet is configured to supply temperature control fluid to a print head control circuit board cooler and at least one temperature control fluid inlet is configured to return the temperature control fluid from print head control circuit board cooler to the manifold. This allows using the temperature control fluid from the manifold to cool print head control circuit boards, in particular the firing pulse generator for piezoelectric print heads. A separate unit for cooling the electronics is thus not necessary.

In a further embodiment, the main body of the manifold comprises a thermally conductive substantially flat outer surface which is thermally connected to the temperature control fluid cavity. The flat surface allows mounting driving and/or control electronics directly on top of the manifold. Preferably, the main body surface consists of metal, in particular 3D-printed titanium. This material has a high thermal conductivity of >20 W/m*K and can effectively dissipate heat from contacting circuit boards.

Further advantages and features will become apparent from the following description of the invention and from the appended figures, which show a non-limiting exemplary embodiment of the invention and in which:

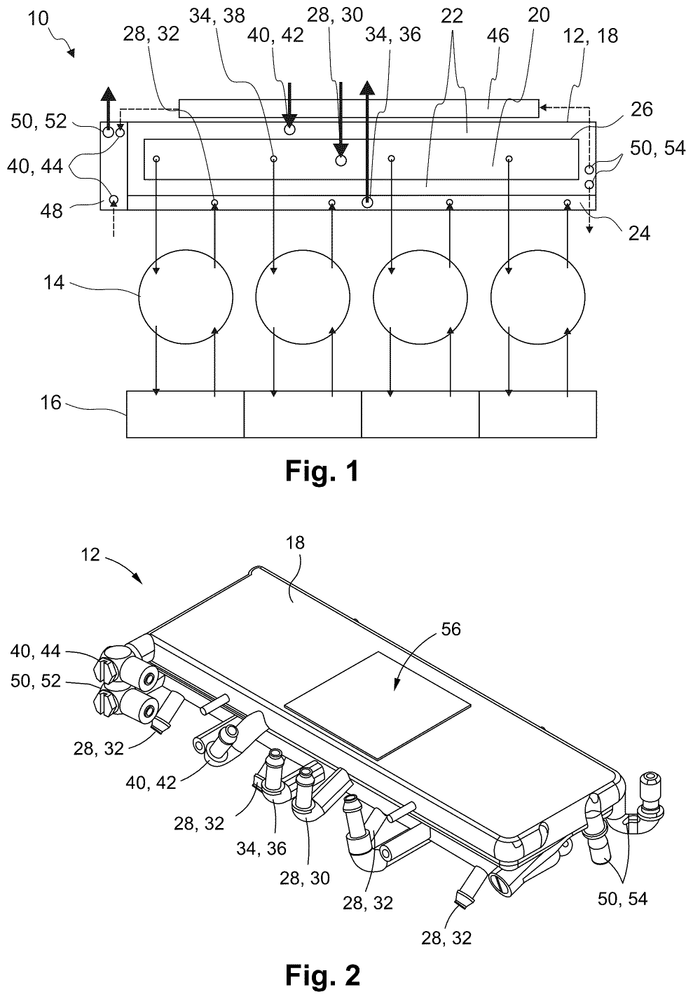

FIG. 1 schematically shows a side view of a printing unit for an inkjet printer;

FIG. 2 shows a schematic 3D illustration of a manifold according to the invention;

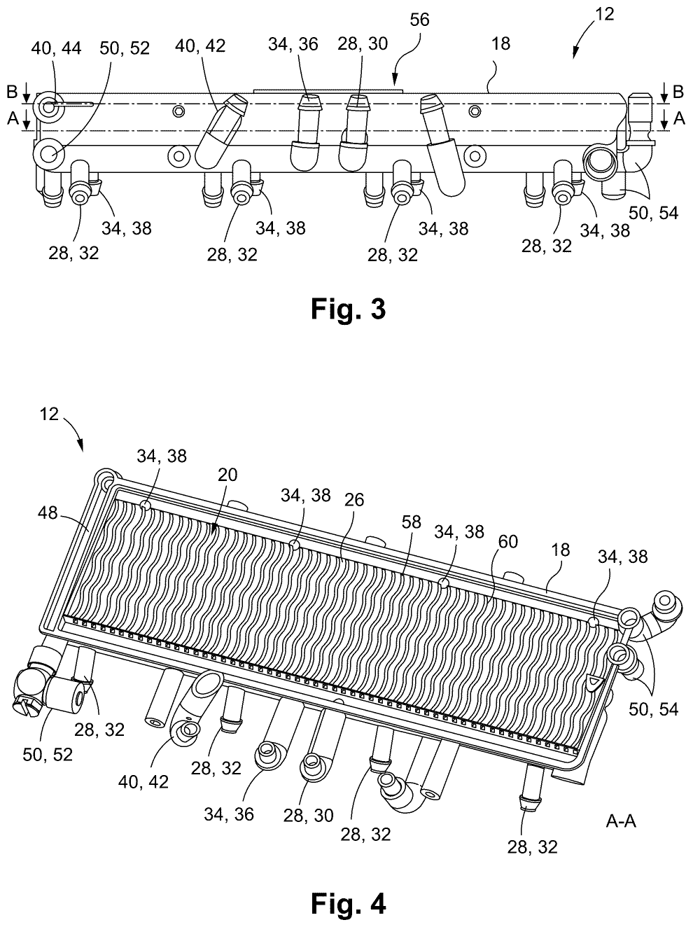

FIG. 3 shows a side view of the manifold of FIG. 2;

FIG. 4 shows a schematic 3D illustration of cross section A-A of FIG. 3;

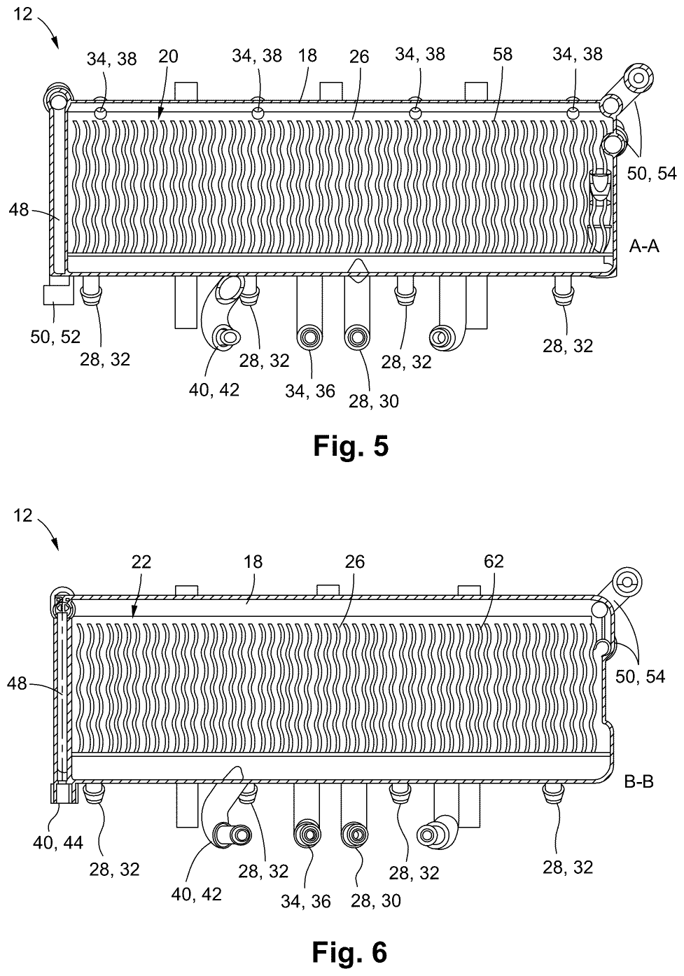

FIG. 5 shows a schematic top view of cross section A-A of FIG. 3; and

FIG. 6 shows a schematic top view of cross section B-B of FIG. 3.

FIG. 1 schematically shows a side view of a printing unit 10 for an industrial single pass inkjet printer. It is conceivable that the inkjet printer is equipped with multiple such printing units 10, which form a stack that defines the print width of the printer.

The printing unit 10 comprises a manifold 12, four ink conditioners 14 and four piezoelectric inkjet print heads 16, for example Dimatix Samba print heads with a plurality of individually addressable nozzles arranged on a trapezoidal nozzle plate.

The manifold 12 comprises a main body 18 with an ink cavity 20, a temperature control fluid cavity 22, which is in thermal contact with the ink cavity 20, and an ink collection cavity 24.

A thermally conductive wall 26, which is part of the main body 18, separates the ink cavity 20 and the temperature control fluid 22 cavity from each other such that ink cannot get in direct contact with the temperature control fluid.

In the given example, the control fluid cavity 22 surrounds the ink cavity 20 at its bottom as well as the top side. This enables a fast and precise temperature adjustment of ink inside the ink cavity 20 by heat conduction through the wall 26.

The manifold 12 further comprises a plurality of ink inlets 28 through which ink can enter the manifold 12, in particular a main ink inlet 30 and four ink return inlets 32.

The main ink inlet 30 is adapted to connect an ink supply, for example an ink reservoir, to the ink cavity 20 within the main body 18.

The four ink return inlets 32 are adapted to connect ink outlets of the print heads 16 and/or conditioners 14 to the ink return cavity 24.

The manifold 12 further comprises a plurality of ink outlets 34 through which ink can leave the manifold 12, in particular a main ink outlet 36 and four print head feed outlets 38.

The main ink outlet 36 is configured to drain ink from the ink return cavity 24, for example into an ink purification unit and/or ink store or into the ink cavity 20.

The four print head feed outlets 38 are each adapted to be connected to a corresponding conditioner inlet or print head inlet and thus to supply ink from the ink cavity 20 to the conditioner 14 and/or print head 16 for printing.

In the described embodiment, the ink may flow for example from an ink store into the ink cavity 20 within the manifold 12, where it is heated or cooled to a certain temperature. The ink may further flow from the ink cavity 20 into the conditioners 14 and/or the print heads 16, where part of the ink is ejected from the nozzles. The remaining ink may further flow from the conditioners 14 and/or the print heads 16 into the ink return cavity 24 of the manifold 12 and from the ink return cavity 24 into a purification unit and/or ink store and eventually back into the ink cavity 20. In other words, the manifold 12 can be part of an ink circulation system. Ink may for example circulate between the manifold 12 and the print heads 16 and/or ink conditioner 14 during a printing process.

The manifold 12 further comprises a plurality of temperature control fluid inlets 40 through which temperature control fluid can enter the manifold 12, in particular a main temperature control fluid inlet 42 and two or more temperature control fluid return inlets 44.

The main temperature control fluid inlet 42 is adapted to be connected to a chiller such that temperature control fluid of a certain temperature can be supplied from the chiller via the main temperature control fluid inlet 42 into the temperature control fluid cavity 22.

The two or more temperature control fluid return inlets 44 are adapted to connect further parts of the inkjet printer, for example coolers for electronics, in particular coolers for the conditioners 14 and/or the print heads 16 and/or a print head control circuit board coolers 46 (such as a firepulse generator cooler), to the manifold, in particular to the temperature control fluid cavity 22 or to an additional control fluid return cavity 48, such that temperature control fluid can flow from the further parts into the manifold 12.

The manifold 12 further comprises a plurality of temperature control fluid outlets 50 through which temperature control fluid can leave the manifold 12, in particular a main temperature control fluid outlet 52 and two or more peripheral temperature control fluid outlets 54.

The main temperature control fluid outlet 52 is adapted to be connected to the chiller such that temperature control fluid can be supplied from the manifold 12, in particular from the control fluid cavity 22 or from the additional control fluid return cavity 48, to the chiller.

The two or more peripheral temperature control fluid outlets 54 are adapted to connect the temperature control fluid cavity 22 to the aforementioned further parts of the inkjet printer that require cooling such that temperature control fluid can flow from the temperature control fluid cavity 22 to these parts.

In the described embodiment, the temperature control fluid may flow for example from the chiller into the temperature control fluid cavity 22 within the manifold 12, from the temperature control fluid cavity 22 to the further parts (e.g. coolers for the conditioners 14 and/or the print heads 16 and/or the firepulse generator cooler 46), from the further parts into the temperature control fluid return cavity 48 and from the temperature control fluid return cavity 48 back into the chiller.

It is conceivable that the described temperature control fluid circulation comprises parallel flow paths, for example one path comprising the firepulse generator cooler 46 and another path comprising coolers for the conditioners 14 and/or the print heads 16. This results in decreased flow resistance of the liquid flow and thus a lower required pump power compared to a series connection.

A schematic 3D illustration of the manifold 12 is shown in FIG. 2. In the described embodiment, the main body 18, the ink inlets 28, the ink outlets 34, the temperature control fluid inlets 40 and the temperature control fluid outlets 50 form a single piece and consist of 3D printed titanium. It is conceivable that the whole manifold 12 as depicted in FIG. 2 forms a single 3D printed structure.

Despite the high number of liquid inlets, outlets and cavities, the manifold 12 does not comprise any sealing or similar parts made from rubber or similar materials. It is thus very robust and due to the inert nature of the titanium surface highly compatible with many different types of inks, in particular inks containing polar and/or nonpolar and/or organic solvents.

In the described embodiment, the upper outer surface 56 of the manifold 12 is flat. As the whole manifold 12 is made of titanium, the surface 56 is thermally connected to the temperature control fluid cavity 22 located directly underneath. It is thus possible to mount driving and/or control electronics, such as firepulse generating circuit boards directly on top of the manifold 12 and to dissipate their processing and/or waste heat through the outer shell of the manifold 12. This enables an efficient cooling process and a compact design of the printing unit 10.

FIG. 3 shows a side view of the manifold 12 with two indicated cross section lines A-A and B-B.

FIG. 4 and FIG. 5 depict the first cross section A-A of FIG. 3, showing a cut through the ink cavity 20.

In the described embodiment, the main body 18 comprises a plurality of thermally conductive lamellae 58 within the ink cavity 20.

The lamellae 58 extend perpendicularly from the thermally conductive wall 26 through the ink cavity 20, thereby separating the ink cavity 20 into a plurality of thin elongated chambers. In order to enable an ink flow between these chambers, each lamella 58 comprises a plurality of equidistantly spaced circular holes 60 through which ink can pass. In this way, a laminar ink flow with homogeneous flow velocity distribution throughout the whole ink cavity 20 can be achieved.

Furthermore, the lamella 58 increase the contact surface between the manifold 12 and the ink flowing through the ink cavity 20. This enables fast transfer of thermal energy from the titanium structure of the manifold 12 to the ink and thus rapid heating and/or cooling of the ink.

FIG. 6 shows the second cross section B-B of FIG. 3, illustrating a cut through the temperature control fluid cavity 22.

In the embodiment, also the control fluid cavity 22 is equipped with lamellae 62, which form part of the main body 18. Similar to the ink chamber lamellae 58, also the temperature control chamber lamellae 62 improve the transfer of thermal energy and homogenize the flow velocity across the cavity.

As shown in FIGS. 5 and 6, the ink chamber lamellae 58 and the temperature control chamber lamellae 62 can have the same orientation. Alternatively, the ink chamber lamellae 58 and the temperature control chamber lamellae 62 can be oriented perpendicularly to each other. The lamellae 62 of FIG. 6 could for example be oriented horizontally instead of vertically. Such orientation can result in an increased heat transfer rate and/or decreased flow resistance of the temperature control fluid inside the control fluid cavity 22 and thus lower required pump power.

1. A manifold for an inkjet printer, the manifold comprising:
a main body with an ink cavity,
a temperature control fluid cavity which is in thermal contact with the ink cavity,
at least one ink inlet,
at least one ink outlet,
at least one temperature control fluid inlet, and
at least one temperature control fluid outlet,
wherein the main body, the at least one ink inlet, the at least one ink outlet, the at least one temperature control fluid inlet, and the at least one temperature control fluid outlet include a same material and form a single piece.

2. The manifold according to claim 1, wherein the main body, the at least one ink inlet, the at least one ink outlet, the at least one temperature control fluid inlet and the at least one temperature control fluid outlet consist of a 3D-printed metal.

3. The manifold according to claim 1, wherein the main body, the at least one ink inlet, the at least one ink outlet, the at least one temperature control fluid inlet and the at least one temperature control fluid outlet consist of titanium.

4. The manifold according to claim 1, wherein the main body comprises a thermally conductive wall separating the ink cavity and the temperature control fluid cavity.

5. The manifold according to claim 4, wherein the main body comprises a plurality of thermally conductive lamellae within the ink cavity.

6. The manifold according to claim 5, wherein the lamellae extend perpendicularly from the thermally conductive wall through the ink cavity.

7. The manifold according to claim 5, wherein each of the lamellae comprises at least one opening for ink to pass through.

8. The manifold according to claim 1, wherein the main body comprises a plurality of thermally conductive lamellae within the temperature control fluid cavity.

9. The manifold according to claim 1,
wherein the at least one ink outlet includes at least four ink outlets, each configured to supply ink to a corresponding print head and/or ink conditioner, and
wherein the at least one ink inlet includes at least four ink inlets, each configured to return ink from the corresponding print head and/or ink conditioner such that ink can circulate between the manifold and the print heads and/or ink conditioners during a printing process.

10. The manifold according to claim 1, wherein the at least one temperature control fluid outlet is configured to supply temperature control fluid to a print head control circuit board cooler and wherein the at least one temperature control fluid inlet is configured to return the temperature control fluid from print head control circuit board cooler to the temperature control fluid cavity or a temperature control fluid return cavity within the manifold.

11. The manifold according to claim 1, wherein the main body comprises a thermally conductive substantially flat outer surface which is thermally connected to the temperature control fluid cavity.
